(19) United States
(12) Patent Application Publication
(10) Pub. No.: US 2024/0095514 A1
(43) Pub. Date: Mar. 21, 2024

(54) FRIEND-TRAINING: METHODS, SYSTEMS, AND APPARATUS FOR LEARNING FROM MODELS OF DIFFERENT BUT RELATED TASKS

(71) Applicant: TENCENT AMERICA LLC, Palo Alto, CA (US)

(72) Inventor: Lifeng JIN, Mill Creek, WA (US)

(73) Assignee: TENCENT AMERICA LLC, Palo Alto, CA (US)

(21) Appl. No.: 17/941,417

(22) Filed: Sep. 9, 2022

(51) Int. Cl. G06N 3/08; G06K 9/62; G06N 3/04

(52) U.S. Cl. CPC G06N 3/08; G06K 9/6215; G06K 9/623; G06N 3/0454

(57) ABSTRACT

Method, apparatus, and non-transitory storage medium for training two or more cross-task neural network models based on two or more neural network tasks, including mapping first pseudo labels based on a first model associated with a first task among the two or more neural network tasks and second pseudo labels based on a second model associated with a second task among the two or more neural network tasks to a same space, and computing a matching score indicating a cross-task matching between the first pseudo labels and the second pseudo labels based on the mapping. The method may further include selecting one or more cross-task pseudo labels based on the matching score and accuracies associated with the first model and the second model, and training the two or more cross-task neural network models based on the one or more cross-task pseudo labels.

### FIELD

Embodiments of the present disclosure relate to language processing using artificial intelligence and machine learning. More specifically, embodiments of the present disclosure relate to training different but related tasks.

### BACKGROUND

Many different machine learning algorithms, such as self-supervised learning, semi-supervised learning, and weakly supervised learning, aim at using unlabeled data for training effectively. With the increasing availability of unlabeled data, the above-mentioned supervised learning algorithms are of even greater interest. Self-training is one semi-supervised learning mechanism that aims to improve model performance by utilizing pseudo-labels of the unlabeled data, and has been successfully applied to computer vision, natural language processing, and other fields.

However, current self-training algorithms primarily focus on a single task and often a single dataset. Current self-training algorithms, because of their solitary application, do not leverage shared properties of input across related tasks.

Therefore, new methods, algorithms, systems, and apparatus are needed for supervised learning that enable learning from different task types and analyze certain properties of the inputs that are shared across related tasks.

### SUMMARY

According to embodiments, a method for training two or more cross-task neural network models based on two or more neural network tasks may be provided. The method may include mapping first pseudo labels based on a first model associated with a first task among the two or more neural network tasks and second pseudo labels based on a second model associated with a second task among the two or more neural network tasks to a same space; computing a matching score indicating a cross-task matching between the first pseudo labels and the second pseudo labels based on the mapping; selecting one or more cross-task pseudo labels based on the matching score and accuracies associated with the first model and the second model; and training the two or more cross-task neural network models based on the one or more cross-task pseudo labels.

According to embodiments, an apparatus for training two or more cross-task neural network models based on two or more neural network tasks may be provided. The apparatus may include at least one memory configured to store program code; and at least one processor configured to read the program code and operate as instructed by the program code. The program code may include mapping code configured to cause the at least one processor to map first pseudo labels based on a first model associated with a first task among the two or more neural network tasks and second pseudo labels based on a second model associated with a second task among the two or more neural network tasks to a same space; computing code configured to cause the at least one processor to compute a matching score indicating a cross-task matching between the first pseudo labels and the second pseudo labels based on the mapping; selecting code configured to cause the at least one processor to select one or more cross-task pseudo labels based on the matching score and accuracies associated with the first model and the second model; and training code configured to cause the at least one processor to train the two or more cross-task neural network models based on the one or more cross-task pseudo labels.

According to embodiments, a non-transitory computer-readable medium storing instructions may be provided. The instructions, when executed by at least one processor for training two or more cross-task neural network models based on two or more neural network tasks, may cause the at least one processor to map first pseudo labels based on a first model associated with a first task among the two or more neural network tasks and second pseudo labels based on a second model associated with a second task among the two or more neural network tasks to a same space; compute a matching score indicating a cross-task matching between the first pseudo labels and the second pseudo labels based on the mapping; select one or more cross-task pseudo labels based on the matching score and accuracies associated with the first model and the second model; and train the two or more cross-task neural network models based on the one or more cross-task pseudo labels.

### BRIEF DESCRIPTION OF THE DRAWINGS

FIG. 1 is a diagram of an environment in which methods, apparatuses, and systems described herein may be implemented, according to embodiments.

FIG. 2 is a block diagram of example components of one or more devices of FIG. 1.

FIG. 3 is a diagram of an exemplary method for training two or more cross-task neural network models based on two or more neural network tasks, according to embodiments.

FIG. 4 illustrates a flowchart for training two or more cross-task neural network models based on two or more neural network tasks, according to embodiments.

### DETAILED DESCRIPTION

Embodiments of the present disclosure relate to methods, apparatus, and systems for training two or more cross-task neural network models based on two or more neural network tasks.

As stated above, many different machine-learning algorithms, such as self-supervised learning, semi-supervised learning, and weakly supervised learning, aim at using unlabeled data for training effectively. With the increasing availability of unlabeled data, the above-mentioned supervised learning algorithms are of even greater interest. Self-training is one semi-supervised learning mechanism that aims to improve model performance by utilizing pseudo-labels of the unlabeled data, and has been successfully applied to computer vision, natural language processing, and other fields. However, current self-training algorithms primarily focus on a single task and often a single dataset. Current self-training algorithms, because of their solitary application, do not leverage shared properties of input across related tasks.

Therefore, new methods, algorithms, systems, and apparatus are needed for supervised learning that enable learning from different task types and analyze certain properties of the inputs that are shared across related tasks. Embodiments of the present disclosure leverage learning from different task types using “friend-training,” a novel cross-task self-training framework.

Shared properties may include certain span boundaries in dependency and constituency parsing, and some categories in sentiment analysis and emotion detection. As an example, two dialogue understanding tasks, conventional semantic role labeling (CSRL) and dialogue rewriting (DR) may have shared properties such as co-reference and zero-pronoun resolution. Such supervision from friend tasks—different but related tasks—may serve as a great criterion for assessing the quality of pseudo-labels. Therefore, embodiments of the present disclosure focus on how to leverage cross-task supervision from related tasks in self-training.

Compared to self-training in related art, friend-training as disclosed herein may exploit supervision from friend tasks for better selection of pseudo-labels. To use such supervision, two novel modules are proposed in the present disclosure to incorporate supervised signals from friend tasks. A first module may include a translation matcher, which may map the pseudo-labels of different tasks for one instance into a same space and may compute a matching score representing the cross-task matching degree among the models. A second module may include an augmented selector, which may leverage both the confidence of pseudo-labels from task-specific models and the matching score to select pseudo-labels of high quality.

In related art, self-training aims at iteratively refining a model of a single task by using both labeled data and a large amount of unlabeled data. At each iteration, the self-trained model may first assign the unlabeled data with pseudo-labels. Subsequently a set of the unlabeled instances with pseudo-labels may be selected for training, with information for better model generalization. Then the cross-entropy of model predictions and labels on both gold and pseudo-labeled data may be minimized to update the model:

$$L = {\sum }_{i = 1}^{N} {y}_{i} log \frac{{y}_{i}}{{p}_{i}} + λ {\sum }_{i = 1}^{{N}^{′}} {y}_{i} log \frac{{y}_{i}}{{p}_{i}} \qquad Eqn ( 1 )$$

Where the first term (i.e., left term) may be a loss for the labeled data and the second term (i.e., right term) may be a loss for the unlabeled data, λ may be a coefficient to balance the first and second terms; N(N′) may be the number of instances, y (y′) may be the label, and p (p′) may be the output probability of the model.

For friend-training with two tasks (two tasks is merely exemplary, friend-training may be extended to a plurality of models more than two models), two classifiers fₐ and f_{b} may be trained on two different tasks with labeled training sets with expected accuracies ηₐ and η_{b}. The two datasets may be created independently and the prediction targets of the two tasks may be partially related through a pair of translation functions:

[symbol]

ₐ: [symbol] →Σ Eqn (2)

[symbol]

_{b}: [symbol] →Σ Eqn (3)

Where Σ may be the set of possible sub-predictions that all possible predictions of the two tasks [symbol] and [symbol] can be reduced to: | [symbol] |≥|Σ|, | [symbol] |≥|Σ|. The translation functions may be general functions with the expected confusion probability

$${ϵ}_{ℱ} = \frac{1}{\vert Σ \vert} .$$

The translation functions may be deterministic and always map the gold labels of the tasks to the same translation.

Both classifiers may make predictions on the unlabeled set [symbol] at iteration k. Some instances [symbol] , with pseudo-labels are chosen as new training data based on predictions from both classifiers translated by the translation functions and some selection criteria, such as total agreement. If total agreement is used as the selection criterion, the probability of erroneous predictions for fₐ in these instances is:

$${Pr}_{x} [ {f}_{a} ( x ) \neq {f}_{a}^{*} ( x ) \vert {ℱ}_{a} ( x ) = {ℱ}_{b} ( x ) ] = 1 - \frac{{η}_{a} {Pr}_{x} [ {ℱ}_{a} ( x ) = {ℱ}_{b} ( x ) \vert {f}_{a} ( x ) = {f}_{a}^{*} ( x ) ]}{{Pr}_{x} [ {ℱ}_{a} ( x ) = {ℱ}_{b} ( x ) ]} \qquad Eqn ( 4 )$$

Because both classifiers may be very different due to training data, models, prediction targets, etc. being different, the two classifiers may very likely be independent from each other. Under this condition above Eqn (4) becomes:

$$1 - \frac{{η}_{a} ( {η}_{b} + {ϵ}_{ℱ} ( 1 - {η}_{b} ) )}{{Pr}_{x} [ {ℱ}_{a} ( x ) = {ℱ}_{b} ( x ) ]} = 1 - \frac{Z}{Z + {η}_{b} {ϵ}_{ℱ} ( 1 - {η}_{a} ) + E} \qquad Eqn ( 5 )$$

$$Where Z = {η}_{a} ( {η}_{b} + {ϵ}_{ℱ} ( 1 - {η}_{b} ) ) and E = {∈}_{ℱ}^{2} ( 1 - {η}_{a} ) ( 1 - {η}_{b} )$$

The above-mentioned equations indicate that the quality of the picked instances is negatively correlated with the number of false positive instances brought by the noisy translation [symbol] (1−ηₐ), and the number of matching negative instances E. When the confusion probability [symbol] is minimized by choosing translation functions with a sufficiently large co-domain Σ, the probability of error instances chosen when two classifiers agree approaches 0. This also indicates that even when 1−ηₐ is large, i.e. fₐ performs badly, if the co-domain is large, the error rate of the chosen instances can still be kept very low. As the dependence between the two classifiers grows in training, the probability of error instances also increases. When they are completely dependent on each other, Equation 4 becomes 1−ηₐ, i.e. classic self-training.

To reduce and keep the error rate low, two additional modules may be needed. A first module may include translation matcher that may map predictions of two models trained on different—but related—tasks into the same space and computes a matching score. A second module may include an augmented (instance) selector which may select instances with pseudo-labels for the classifiers considering both the matching score of the translated predictions and the model confidences.

Translation Matcher—given the models of two friend tasks, the pseudo-labels {vₐ, v_{b}} may be received from the models. The translation matcher [symbol] may compute a matching score m for the pair of pseudo-labels, which represents the similarity of the pair in the translation space, with total agreement being 1.

m_{a,b}= [symbol] (vₐ,v_{b}) Eqn (6)

The matching score may serve as a criterion for the selection of high-quality pseudo-labels with cross-task supervision.

Augmented Selector—may select pseudo labels based on not just the pseudo-label similarity (i.e., matching score), but also based on other sources of information about pseudo-label quality, e.g., model confidence indicators, to augment matching scores. The augmented selector may consider both the confidence (also referred to as accuracy) of the pseudo-labels from task-specific models, denoted as {cₐ, c_{b}} and the matching scores.

q_{τ}=S_{τ}(m_{τ},c_{τ}) Eqn (7)

Where q_{τ}∈{0,1} may represent the selection result of the pseudo-label for task τ∈a, b. Therefore, instances with low matching scores but high confidence may also be selected as the training data.

An exemplary algorithm for friend-training is disclosed below.

Algorithm 1-Friend-Training Cross-
Task Neural Network Models
Algorithm 1: Two-task friend-training

| Input :Labeled data sets for two | | |
|---|---|---|
| friend-tasks, [symbol] ₐ, [symbol] _{b}; an unlabeled | | |
| data set [symbol] ; task-specific models | | |
| fₐ, f_{b}. | | |
| Output:Refined fₐ, f_{b}. | | |
| Pre-train f_{τ} with [symbol] _{τ} (τ ∈ a, b); | | |
| while not until the maximum iteration do | | |
| \| | [symbol] ₐ^{u} = 0; [symbol] _{b}^{u} = 0; | |
| \| | for z in [symbol] do | |
| \| | \| | Generate vₐ, v_{b} and cₐ, c_{b}; |
| \| | \| | m_{a,b} ← Equation 4; |
| \| | \| | q_{a,} q_{b} ← Equation 5; |
| \| | \| | if qₐ = 1 then |
| \| | \| | \| [symbol] ₐ^{u} = [symbol] ₐ^{u} + {z, vₐ}; |
| \| | \| | if q_{b} = 1 then |
| \| | \| | \| [symbol] _{b}^{u} = [symbol] _{b}^{u} + {z, v_{b}}; |

| | |
|---|---|
| \| | end |
| \| | Update f_{τ} with [symbol] _{τ}, [symbol] _{τ}^{u} by Equation 1 |
| \| | (τ ∈ a, b); |

end
Return fₐ, f_{b};

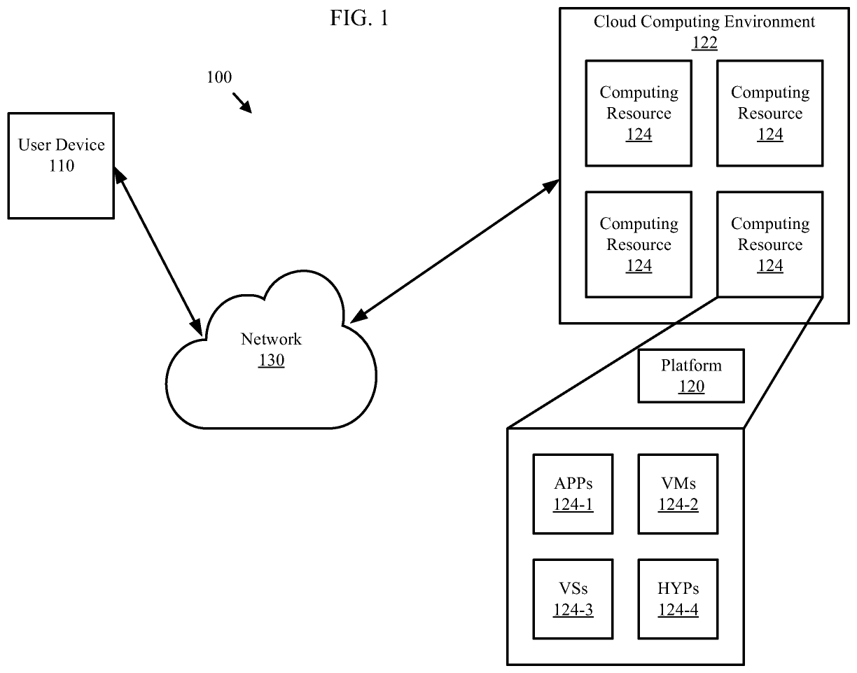

FIG. 1 is a diagram of an environment 100 in which methods, apparatuses and systems described herein may be implemented, according to embodiments.

As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

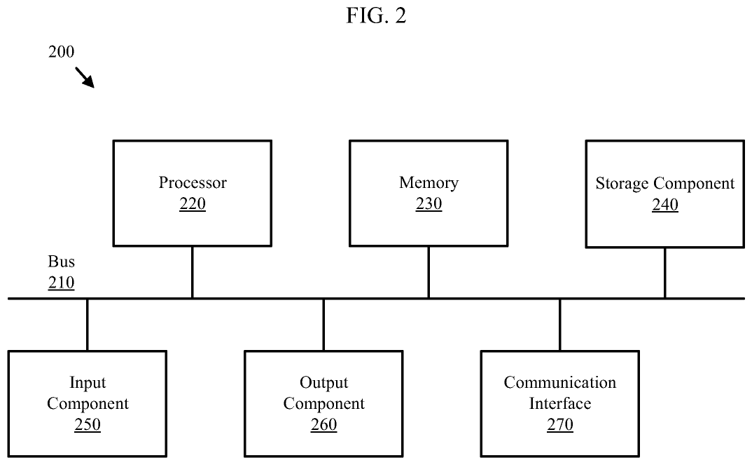

FIG. 2 is a block diagram of example components of one or more devices of FIG. 1.

A device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). Additionally, or alternatively, the input component 250 may include a sensor for sensing information (e.g., a global positioning system (GPS) component, an accelerometer, a gyroscope, and/or an actuator). The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

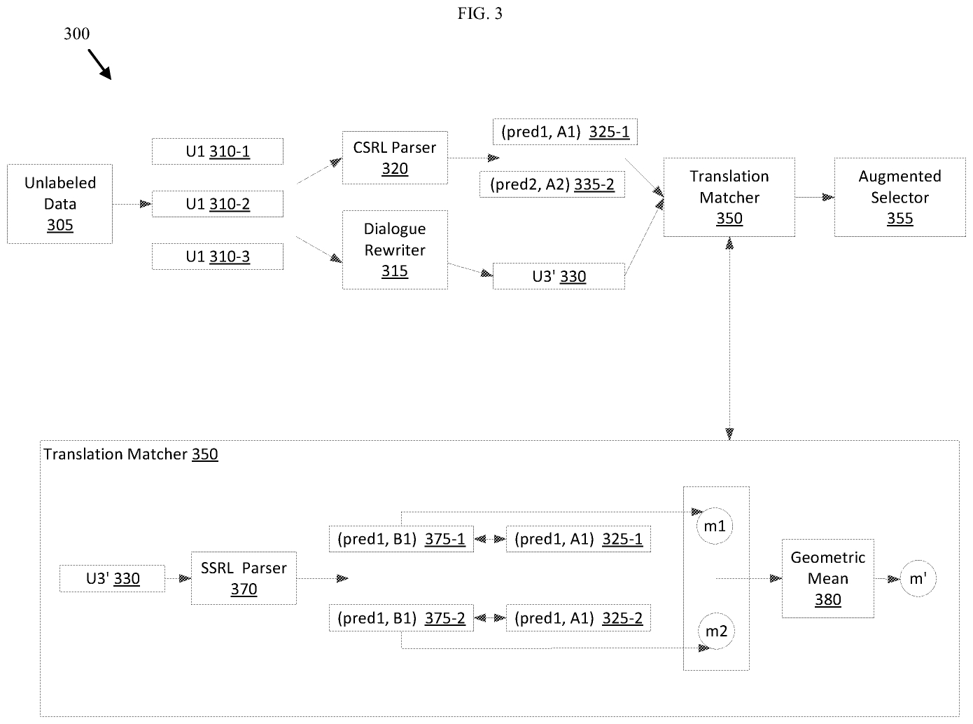

FIG. 3 is a diagram of an exemplary process training two or more cross-task neural network models based on two or more neural network tasks. As shown in FIG. 3, process 300 is an exemplary process for friend-training CSRL and DR models.

Embodiments may be described in detail using an example of CSRL and DR as candidate tasks. Experimental results of friend-training, unsupervised domain adaptation, and few-shot learning show that friend-training surpasses both classical and state-of-the-art semi-supervised learning algorithms by a large margin. It may be understood that the use of CSRL and DR as candidate tasks is merely exemplary. Appropriate other related tasks may be used instead.

While both CSRL and DR utilize skills such as co-reference and zero-pronoun resolution, the two tasks focus on different properties of the dialogue utterance. CSRL may extract arguments of the predicates in the utterance from the whole dialogue history. DR may rewrite the last turn of a dialogue to make it context-free and fluent by recovering all the ellipsis and co-reference in the utterance.

Unlabeled data 305 may include dialogues that may consist of N temporally ordered utterances {u₁, . . . , u_{N}}. Given utterance uₜ (e.g., u₁ 310-1, u₂ 310-2, etc.) and K predicates {pred₁, . . . , pred_{K}} of uₜ, a CSRL parser 320 may predict spans from the dialogue as arguments for all predicates. A dialogue rewriter 315 may rewrite uₜ to make it context-free according to its context {u₁, . . . , uₜ₋₁}. Dialogue context {u₁, . . . , uₜ₋₁} and the current utterance uₜ may be concatenated as a sequence of tokens {x₁, . . . , x_{M}} and encoded with BERT (or any suitable model) to get the contextualized embeddings:

E=e₁, . . . ,e_{M}=BERT(x₁, . . . ,x_{M})∈ [symbol] ^{H×M} Eqn (8)

Where we use the same notation E for outputs from encoders for CSRL and DR, even though the encoders may not share any parameters.

CSRL: With the contextualized embeddings, predicate-aware utterance representations G={g₁, . . . , g_{M}}∈R^{H×M} may be generated by applying self-attention to E with predicate-aware masking, where a token may only be allowed to attend to tokens in the same utterance and tokens from the utterance containing the predicate. The predicate-aware representations may then be projected by a feed-forward network to get the distribution of labels for each token. The labels may follow a suitable labeling scheme, e.g., BIO sequence labeling scheme—B-X and I-X—respectively denoting that the token is the first token and the inner token of argument X, where O means the token does not belong to any argument. The output of the CSRL parser for K predicates may be denoted as { [symbol] ₁, . . . , [symbol] _{K}} (or e.g., (predₖ, [symbol] _{K}) 325-k), where set [symbol] ₖ may contain the arguments for predₖ.

DR: DR may be considered a sequence labeling task. Specifically, a binary classifier on the top of E may determine whether to keep each token for in utterance uₜ in the rewritten utterance.

P_{d}=softmax_{column-wise}(W_{d}E+b_{d})∈ [symbol] ^{2×M} Eqn (9)

A span of the context tokens may be predicted to be inserted in front of each token. In practice, two self-attention layers may be adopted to calculate the probability of context tokens being the start index or end index of the span:

P^{st}=softmax_{column-wise}(Attnₛₜ(e))∈ [symbol] ^{M×M}

P^{ed}=softmax_{column-wise}(Attn_{ed}(e))∈ [symbol] ^{M×M} Eqn (10) & (11)

Where P_{i,j}^{st} (P_{i,j}^{ed}) denotes the probability of xᵢ being the start (end) index of the span for xⱼ. Then by applying argmax to P, we may obtain the start and end indexes of the span for each token:

s^{st}=argmax_{column-wise}(P^{st})∈ [symbol] ^{M}.

s^{ed}=argmax_{column-wise}(P^{ed})∈ [symbol] ^{M}. Eqn (12) & (13)

The probability of the span to be inserted in front of xₘ may be Pₛ_{ₘ}_{^{st}}_{,m}^{st}×Pₛ_{ₘ}_{^{ed}}_{,m}^{ed} when $$ sₘ^{st}≤sₘ^{ed}. When sₘ^{st}>sₘ^{ed}, there may be no insertion. The output of the dialogue rewriter for uₜ may be denoted as uₜ′ (e.g., u₃′ 330).

Translation Matching

The outputs (pseudo-labels) from the CSRL parser 320 and dialogue rewriter 315 may be in forms of argument lists for predicates, and complete sentences rewritten from dialogue turns. To calculate the matching score between the pseudo-labels of the two tasks, the translation matcher 350 may leverage a normal semantic role labeler 370 to extract arguments from the rewritten utterance uₜ′ 330-t for the K predicates, denoted as { [symbol] ₁, . . . , [symbol] _{K}} (e.g., (predₖ, [symbol] _{K}) 375-k. The matching score mₖ∈[0,1] (e.g., m₁, m₂, etc) for predₖ may be calculated based on the edit distance between [symbol] ₖ and [symbol] ₖ:

$${m}_{k} = 1 - \frac{dist ( ⊕ {𝒜}_{k} , ⊕ {ℬ}_{k} )}{max ( len ( ⊕ {𝒜}_{k} ) , len ( ⊕ {ℬ}_{k} ) )} . \qquad Eqn ( 14 )$$

Where dist( ) may calculate the edit distance between two strings, len( ) may return the length of a string, and ⊕ [symbol] ₖ may denote the concatenation of arguments in set [symbol] ₖ in a predefined order of arguments (e.g., argument concatenating order: ARG0, ARG1, ARG2, ARG3, ARG4, ARGM-TMP, ARGM-LOC, ARGM-PRP) (empty strings may mean arguments do not exist). Furthermore, we obtain the matching score m′∈[0,1] for the rewritten utterance uₜ′ may be follows:

m′=GM(m₁, . . . ,m_{K}) Eqn (15)

Where GM( ) may represent the geometric mean 380. The geometric mean 380 may be an exemplary function used to calculate the matching score, and any appropriate function may be used instead and/or in addition to the geometric mean.

Augmented Selector

The augmented selector may select high-quality pseudo-labels according to both the matching scores and confidence of the respective task models.

For CSRL, we may calculate the confidence score for each predicate based on the output of the softmax layer. Specifically, we obtain the confidence of an argument for predₖ by multiplying the probability of its tokens, denoted as {aₖ₁, . . . , [symbol] }. We then use the geometric mean of all the confidence of arguments belonging to predₖ as the confidence for predₖ. The overall score sₖ∈[0,1] for predₖ is calculated as follows:

sₖ=αGM(aₖ₁, . . . , [symbol] )+(1−α)mₖ Eqn (16)

Where hyper-parameter α may strike a balance between the matching score and the confidence.

For DR, we may multiply the probabilities of spans to be inserted and of decisions on whether to keep tokens or not as the model confidence of uₜ′, denoted as bₜ. The overall score rₜ∈[0,1] of uₜ′ is as follows:

rₜ=βbₜ+(1−β)m′ Eqn (17)

Where a larger value of hyper-parameter β places more importance on the model confidence. Thresholds may be set for sₖ and rₜ to control the number and quality of selected pseudo-labels.

In the context of CSRL and DR, Tables 1 & 2 show a comparison between friend-training according to embodiments of the present disclosure and the several classical or state-of-the-art baselines (e.g., DuConv to WeiboCSRL and/or Rewrite to Restoration). Friend-training (also referred to as “FDT”) achieves the best overall performance over the baselines by significant margins in both unsupervised domain adaptation and few-shot learning scenarios, which demonstrates the effectiveness of friend-training in different experimental situations to utilize large unlabeled corpora.

TABLE 1
Unsupervised Domain Adaptation

| | WeiboCSRL | | | RESTORATION | | |
|---|---|---|---|---|---|---|
| Method | P | R | F1 | R-L | EM | WER( [symbol] ) |
| Base | 57.97 | 54.47 | 56.16 | 82.78 | 25.25 | 28.69 |
| Multitask-Base | 53.66 | 54.32 | 53.99 | 81.68 | 22.49 | 32.44 |
| SST ( [symbol] , 1965) | 60.85 | 56.54 | 58.62 | 85.22 | 32.97 | 22.22 |
| MT ( [symbol] and Valpola, 2017) | 58.42 | 55.71 | 57.03 | 83.76 | 28.82 | 26.49 |
| CPS (Chen et al., 2021) | 60.34 | 52.87 | 56.36 | 85.60 | 32.68 | 22.78 |
| SCoT (Blum and Mitchell, 1998) | 57.33 | 54.13 | 55.69 | 84.51 | 29.25 | 24.87 |
| STBR (Bhat et al., 2021) | 60.77 | 58.04 | 59.38 | 85.79 | 33.78 | 23.30 |
| STea (Yu et al., 2021) | 60.10 | 55.13 | 57.50 | 85.75 | 34.23 | 22.17 |
| FDT (Ours) | 65.29 | 58.63 | 61.78 | 86.82 | 38.22 | 20.31 |
| | (†7.2%) | (†3.6%) | (†5.3%) | (†1.8%) | (†15.9%) | (†8.5%) |

[symbol]

indicates data missing or illegible when filed

TABLE 2
Few-Shot Learning

| | DuConv | | | REWRITE | | |
|---|---|---|---|---|---|---|
| Method | P | R | F1 | R-L | EM | WER( [symbol] ) |
| Full-trained Base | 69.83 | 68.53 | 69.17 | 89.47 | 52.30 | 20.54 |
| Base | 29.50 | 21.90 | 25.14 | 73.44 | 3.60 | 39.98 |
| Multitask-Base | 22.43 | 20.63 | 21.49 | 78.97 | 11.70 | 40.46 |
| SST (Scudder, 1965) | 34.16 | 27.49 | 30.46 | 80.93 | 27.80 | 31.02 |
| MT ( [symbol] and Valpola, 2017) | 36.32 | 30.69 | 33.27 | 81.66 | 33.00 | 31.66 |
| CPS (Chen et al., 2021) | 37.14 | 29.47 | 32.86 | 79.56 | 23.30 | 32.60 |
| SCoT (Blam and Mitchell, 1998) | 38.37 | 26.15 | 31.10 | 78.58 | 22.31 | 33.79 |
| STBR (Bhat et al., 2021) | 32.37 | 25.21 | 28.34 | 82.37 | 29.80 | 30.31 |
| STea (Yu et al., 2021) | 39.34 | 28.78 | 33.25 | 83.04 | 31.57 | 30.36 |
| FDT (Ours) | 40.41 | 30.82 | 34.97 | 82.83 | 34.20 | 27.87 |
| | (†18.2%) | (†12.1%) | (†14.8%) | (†2.3%) | (†23.0%) | (†10.1%) |
| FDT-S (Ours) | 40.12 | 33.41 | 36.46 | 83.11 | 37.10 | 26.88 |

[symbol]

indicates data missing or illegible when filed

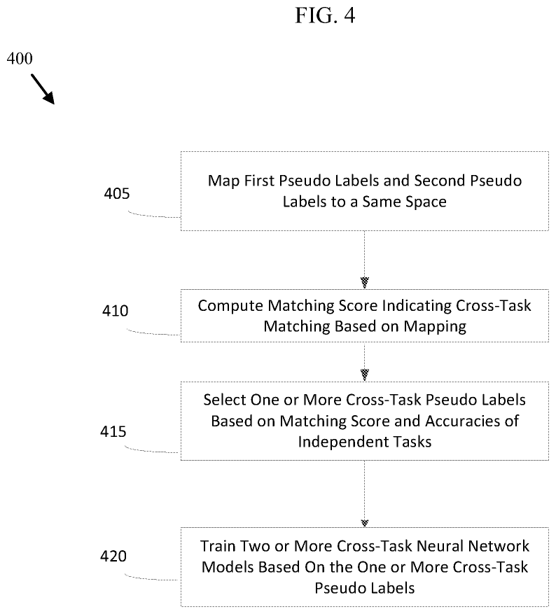

FIG. 4 is an illustration of an exemplary process 400 for training two or more cross-task neural network models based on two or more neural network tasks, according to embodiments.

At operation 405, first pseudo labels based on a first model associated with a first task among the two or more neural network tasks may be mapped to a same space as second pseudo labels based on a second model associated with a second task among the two or more neural network tasks. As an example, pseudo labels from the CSRL task may be mapped to pseudo labels from the DR task. The mapping may indicate a measure of similarity of the first pseudo labels and the second pseudo labels.

At operation 410, a matching score indicating a cross-task matching between the first pseudo labels and the second pseudo labels may be computed based on the mapping. In some embodiments, the matching score may be based on an edit distance between the first pseudo labels and the second pseudo labels. In some embodiments, the matching score may be a value between zero and one.

At operation 415, one or more cross-task pseudo labels may be selected based on the matching score and accuracies associated with the first model and the second model. Selecting the one or more cross-task pseudo labels may be based on a threshold total agreement criteria.

In some embodiments, the accuracies associated with the first model and the second model may include a first accuracy based on a respective first function of the first pseudo labels associated with the first task (e.g., accuracy of the CSRL task). In some embodiments, the accuracies associated with the first model and the second model may also include a second accuracy based on a respective second function of the second pseudo labels associated with the second task (e.g., accuracy of the DR task).

At operation 420, the two or more cross-task neural network models may be trained based on the one or more cross-task pseudo labels. In some embodiments, the two or more neural network tasks may have partially related prediction tasks. The partially related prediction tasks may be partially related through two or more respective translation functions, the two or more respective translation functions comprising a subset of possible sub-predictions of the two or more neural network tasks.

According to some embodiments, operations 405-420 may be may be executed using an apparatus configured to execute code, each operation corresponding to codes such as receiving code, determining code, generating code, etc.

Embodiments of the present disclosure also provide the flexibility to adjust learning-based substitution, quantization, encoding, and decoding methods, online or offline based on the current data, and support different types of learning-based quantization methods, including DNN-based or conventional model-based methods. The described method also provides a flexible and general framework that accommodates different DNN architectures and a plurality of quality metrics.

The proposed methods may be used separately or combined in any order. Further, each of the methods (or embodiments) may be implemented by processing circuitry (e.g., one or more processors or one or more integrated circuits) or may be implemented using software code (e.g., generating code, receiving code, encoding code, decoding code, etc.). In one example, the one or more processors execute a program that is stored in a non-transitory computer-readable medium.

The present disclosure provides illustration and description, but is not intended to be exhaustive or to limit the implementations to the precise form disclosed. Modifications and variations are possible in light of the present disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein may be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method for training two or more cross-task neural network models based on two or more neural network tasks, the method being executed by at least one processor, the method comprising:
mapping first pseudo labels based on a first model associated with a first task among the two or more neural network tasks and second pseudo labels based on a second model associated with a second task among the two or more neural network tasks to a same space;
computing a matching score indicating a cross-task matching between the first pseudo labels and the second pseudo labels based on the mapping;
selecting one or more cross-task pseudo labels based on the matching score and accuracies associated with the first model and the second model; and
training the two or more cross-task neural network models based on the one or more cross-task pseudo labels.

2. The method of claim 1, wherein the mapping indicates a measure of similarity of the first pseudo labels and the second pseudo labels.

3. The method of claim 1, wherein the selecting the one or more cross-task pseudo labels is based on a threshold total agreement criteria.

4. The method of claim 1, wherein the matching score is a value between zero and one.

5. The method of claim 1, wherein computing the matching score is based on an edit distance between the first pseudo labels and the second pseudo labels.

6. The method of claim 1, wherein the accuracies associated with the first model and the second model comprise:
a first accuracy based on a respective first function of the first pseudo labels associated with the first task; and
a second accuracy based on a respective second function of the second pseudo labels associated with the second task.

7. The method of claim 1, wherein the two or more neural network tasks have partially related prediction tasks.

8. The method of claim 7, wherein the partially related prediction tasks are partially related through two or more respective translation functions, the two or more respective translation functions comprising a subset of possible sub-predictions of the two or more neural network tasks.

9. The method of claim 8, wherein the two or more respective translation functions are deterministic.

10. An apparatus for training two or more cross-task neural network models based on two or more neural network tasks, the apparatus comprising:
at least one memory configured to store program code; and
at least one processor configured to read the program code and operate as instructed by the program code, the program code comprising:
mapping code configured to cause the at least one processor to map first pseudo labels based on a first model associated with a first task among the two or more neural network tasks and second pseudo labels based on a second model associated with a second task among the two or more neural network tasks to a same space;
computing code configured to cause the at least one processor to compute a matching score indicating a cross-task matching between the first pseudo labels and the second pseudo labels based on the mapping;
selecting code configured to cause the at least one processor to select one or more cross-task pseudo labels based on the matching score and accuracies associated with the first model and the second model; and
training code configured to cause the at least one processor to train the two or more cross-task neural network models based on the one or more cross-task pseudo labels.

11. The apparatus of claim 10, wherein the mapping indicates a measure of similarity of the first pseudo labels and the second pseudo labels.

12. The apparatus of claim 10, wherein the selecting the one or more cross-task pseudo labels is based on a threshold total agreement criteria.

13. The apparatus of claim 10, wherein the matching score is a value between zero and one.

14. The apparatus of claim 10, wherein computing the matching score is based on an edit distance between the first pseudo labels and the second pseudo labels.

15. The apparatus of claim 10, wherein the accuracies associated with the first model and the second model comprise:
a first accuracy score based on a respective first function of the first pseudo labels associated with the first task; and
a second accuracy based on a respective second function of the second pseudo labels associated with the second task.

16. The apparatus of claim 10, wherein the two or more neural network tasks have partially related prediction tasks.

17. The apparatus of claim 16, wherein the partially related prediction tasks are partially related through two or more respective translation functions, the two or more respective translation functions comprising a subset of possible sub-predictions of the two or more neural network tasks.

18. A non-transitory computer readable medium storing instructions that, when executed by at least one processor for training two or more cross-task neural network models based on two or more neural network tasks, cause the at least one processor to:
map first pseudo labels based on a first model associated with a first task among the two or more neural network tasks and second pseudo labels based on a second model associated with a second task among the two or more neural network tasks to a same space;
compute a matching score indicating a cross-task matching between the first pseudo labels and the second pseudo labels based on the mapping;
select one or more cross-task pseudo labels based on the matching score and accuracies associated with the first model and the second model; and
train the two or more cross-task neural network models based on the one or more cross-task pseudo labels.

19. The non-transitory computer readable medium of claim 18, wherein the two or more neural network tasks have partially related prediction tasks.

20. The non-transitory computer readable medium of claim 19, wherein the partially related prediction tasks are partially related through two or more respective translation functions, the two or more respective translation functions comprising a subset of possible sub-predictions of the two or more neural network tasks.
